(19) United States
(12) Patent Application Publication
(10) Pub. No.: US 2008/0237218 A1
(43) Pub. Date: Oct. 2, 2008

(54) Electric Room Heater

(76) Inventors: Ratko Isidorovic, Beograd (YU); Janko Isidorovic, Beograd (YU); Ksenija Isidorovic, Beograd (YU)

Correspondence Address: BROOKS KUSHMAN P.C., 1000 TOWN CENTER, TWENTY-SECOND FLOOR, SOUTHFIELD, MI, 48075, US

(21) Appl. No.: 12/065,785

(22) PCT Filed: Aug. 18, 2006
(86) PCT No.: PCT/YU06/00021

§ 371 Date: Mar. 5, 2008

(30) Foreign Application Priority Data
Sep. 6, 2005 (YU) P-2005/0682

(51) Int. Cl. H05B 3/06

(52) U.S. Cl. 219/520

(57) ABSTRACT

Electric Room Heater in its housing contains heaters which consist of strip of oriented cold rolled transformer sheet that are cooled by natural air circulation. Heater consists of two cross supports (11) connected by a central support (14). Between the cross supports are placed non-flammable insulating holders (13). The insulating holders have sprockets. Between sprockets lies strip of the heater of oriented cold rolled transformer sheet (12). The insulating holder (13) by its width (17) creates distance between layers of heater strips, and by sprockets width (18) makes distance between adjacent strips, windings, in the layer. These distances make channels for air circulation, thus enabling strip temperature to be less then 100° C.

### TECHNICAL FIELD

The invention belongs to the field of transformation of electrical energy into thermal energy. The invention is intended to be used to heat rooms, and indoor areas.

The invention deals with the problem of room heating by electrical heater with surface temperature which cannot provoke fire. Due to the lower surface temperature of the heater, it permanently maintains its thermal and mechanical properties. The Electric Room Heater is cooled by natural air circulation. According to International Classification of Patents (ICP) the mark is:

### BACKGROUND ART

When electrical energy is used for room heating it is usually performed by electric heaters with red hot fibre. Red hot fibre has high working temperature. There are several methods of cooling it and preventing it from provoking fire. In order to decrease temperature of the heater, fans are used or the heaters are immersed in thermal oil or similar. The red hot fibre has limited duration time because of its high working temperature.

### DISCLOSURE OF THE INVENTION

Electric Room Heater has a heater made from a wire which is in a form of a strip. Wire is winded up on the insulating holders. Cross-section of the strip is in a form of a narrow and long rectangle. Therefore, cooling surface of the heater is bigger than for a heater which has a circular cross-section with the same cross-section surface. This provides larger surface for cooling and the larger cooling surface enables the heater to work at lower working temperature. Contacts of insulation holders with the strip are covering a small surface of the strip.

Material used for production of striped heater is oriented cold rolled transformer sheet which has electrical resistance that enables lower temperature of transformation of electrical energy into thermal energy. This makes natural air circulation sufficient to cool the heater and to avoid possibility of provoking fire. Maximum temperature of the heater is up to 100° C. Lower temperature does not affect internal structure, mechanical, electrical and thermal properties of the heater and allows the heater to be used for a long time without a failure.

The heater is placed in housing for protection against contacts but required air circulation is provided.

### BRIEF DESCRIPTION OF DRAWINGS

FIG. 1 shows two projections of the housing;

FIG. 2 represents cross-section of the housing to show striped heaters;

FIG. 3 shows the scheme of electric connection;

FIG. 4 shows view on the striped heater from above;

FIG. 5 shows view on the striped heater from aside;

FIG. 6 represents view A to show detail of connecting insulating holder and cross support;

FIG. 7 represents detail B to present leaning of heater strip against insulating holder;

FIG. 8 shows insulating holder with sprockets.

### BEST MODE FOR CARRYING OUT OF THE INVENTION

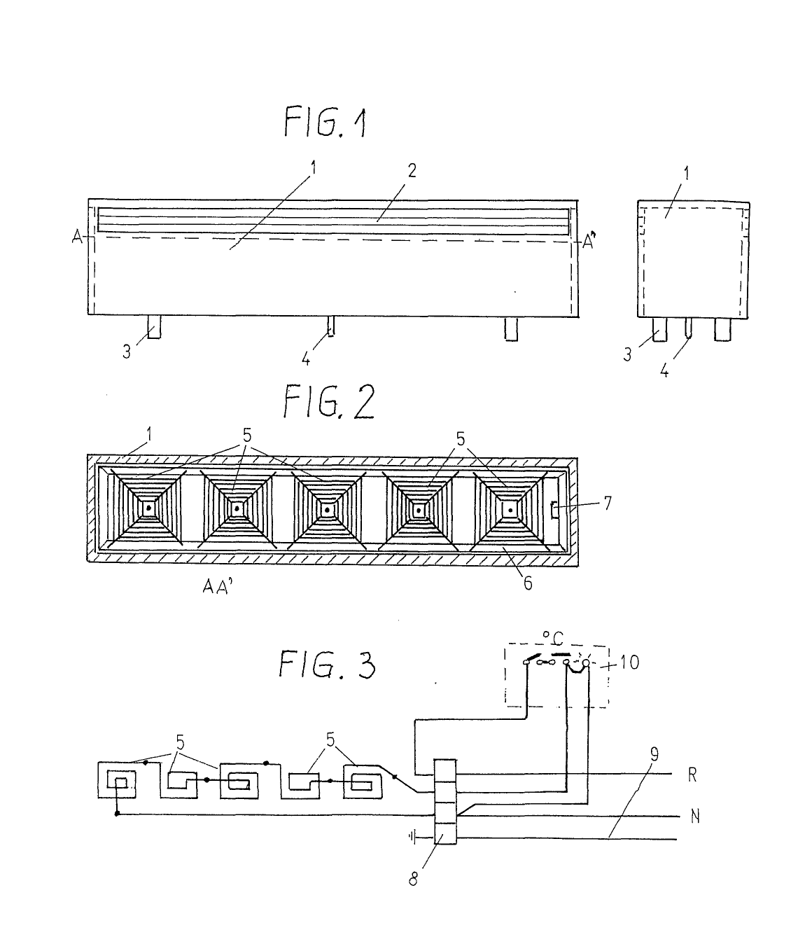

Electric Room Heater, FIG. 1, consists of: housing 1, blinds for air circulation 2, supports 3, they also function as spacers between floor 4 and heater 5. Housing 1 is cut by AA′-axis, FIG. 2, to provide view on heaters 5. The heaters are fixed to a supporting frame 6. There is the frame 6 on the upper side of the heaters also, and it is used for holding the heater in place. Housing 1 is also fixed to the supporting frame. Electric connection of heaters is serial, FIG. 3. Clamp 8 is fixed to holder 7, FIG. 2. The clamp is used to make electrical connections between: heaters 5, connecting cable 9, thermostat, signal lamp and switch 10.

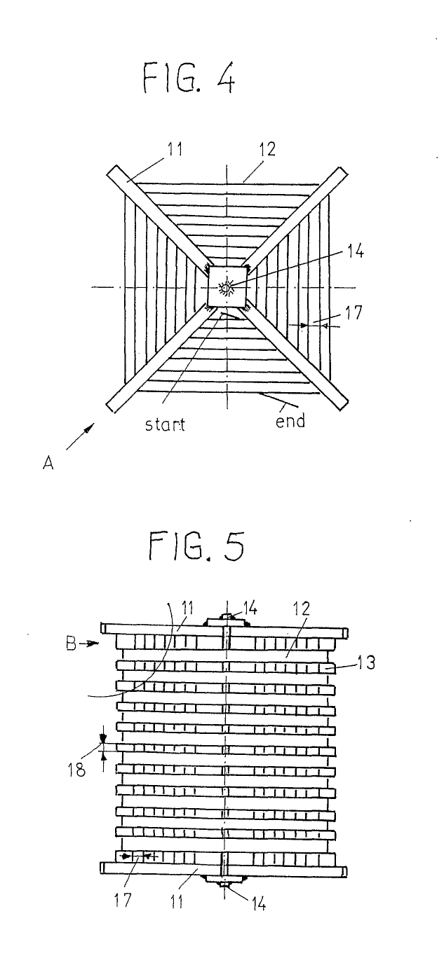

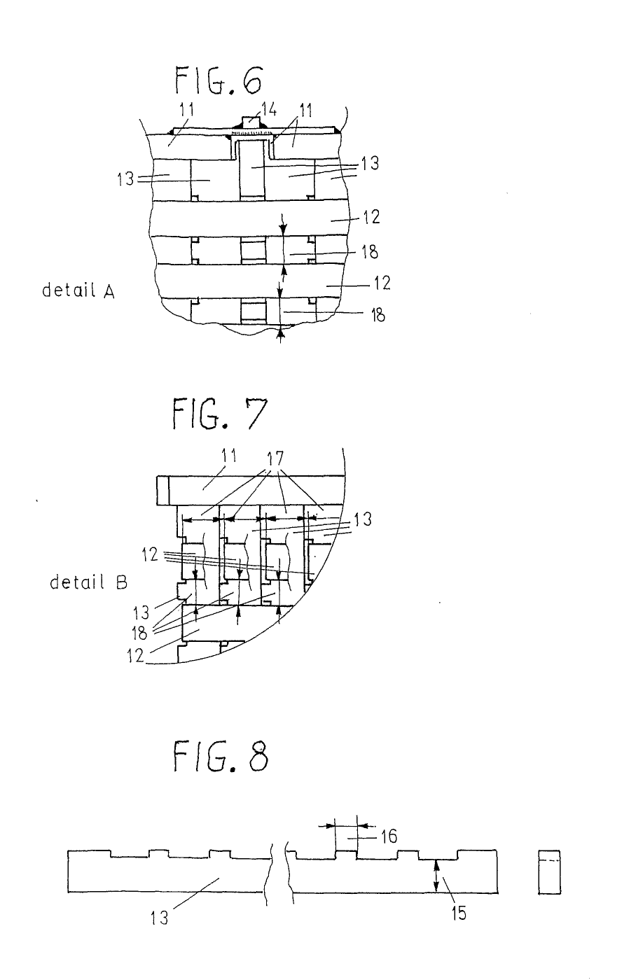

The heater 5, FIG. 4 and FIG. 5, consists of two cross supports 11 connected by a central support 14. Between the cross supports 11, because they are in a form of U profile, are placed non-flammable insulating holders 13, FIG. 6. Insulating holders, FIG. 8, have sprockets. Between the sprockets is placed strip of the heater 12, made of oriented cold rolled transformer sheet, FIG. 6 and FIG. 7. Insulating holder 13 by its width 15 makes distance 17 between layers of heater strips, and by sprockets width 16 creates distance 18 between adjacent windings, that is, adjacent strips. These distances make electric insulation between windings and strip layers. In compliance with the idea of the invention these distances create channels for air circulation thus enabling air to take thermal energy from the strips. Air, on one side, cools the strip and on another side heats the room in which the Electric Room Heater is situated. Also, in harmony with idea of the invention, temperature of the strips does not exceed 100° C. and cannot provoke fire, not even in case when inflammable material, for instance—paper, happens to be in direct contact with the strip. Reduced temperature of the heater does not interfere with the internal structure, thermal, mechanical and electrical properties and the heater cannot brake down because of extended use of the Electric Room Heater.

1. Electric Room Heater for room heating consists of a housing, blinds, supports, frames, a connecting cable, a thermostat, a signalling lamp and a switch, characterized by serial electric connection of heaters, each of the heaters comprising strips of oriented cold rolled transformer sheet wound between sprockets of nonflammable insulating holders the ends of which lie in U profile of the cross supports whereby is obtained necessary vertical and horizontal distances between strips that allow temperature of the strips of the heater to be less then 100° C.
